(19) United States
(12) Patent Application Publication
(10) Pub. No.: US 2017/0103431 A1
(43) Pub. Date: Apr. 13, 2017

(54) SOCIAL MEDIA T-SHIRTS AND PROMOTIONAL ITEMS

(71) Applicants: Phyllis A. Shapiro, Waterford, MI (US); Kevin Mendelson, Palatine, IL (US); Lawrence Melton, SW Wyoming, MI (US)

(72) Inventors: Phyllis A. Shapiro, Waterford, MI (US); Kevin Mendelson, Palatine, IL (US); Lawrence Melton, SW Wyoming, MI (US)

(21) Appl. No.: 15/290,061

(22) Filed: Oct. 11, 2016

Related U.S. Application Data
(60) Provisional application No. 62/240,755, filed on Oct. 13, 2015.

(51) Int. Cl. G06Q 30/02; G06K 7/14; H04N 1/00; G06K 19/06

(52) U.S. Cl. CPC G06Q 30/0277; G06K 19/06037; G06K 7/1417; H04N 1/0019; G06Q 50/01

(57) ABSTRACT

A promotional item including a promotional panel on an outer surface of the promotional item, wherein the promotional panel promotes a company and directs individuals to finding more information about the company through websites and social media sites. A method of making the promotional item, by printing a promotional panel on an outer surface of the promotional item, wherein the promotional panel promotes a company and directs individuals to finding more information about the company through websites and social media sites. A method of advertising by providing a promotional item including a promotional panel associated with a company on an outer surface of the promotional item, and promoting the company.

### BACKGROUND OF THE INVENTION

1. Technical Field

The present invention relates to promotional materials for companies indicating social media presence. More specifically, the present invention relates to promotional garments.

2. Background Art

Many companies rely on the Internet for advertising and promoting their brand. Many companies have an Internet address where users can find information about that company. Companies also promote themselves over social media. Social media or social networking allows companies to share various types of media and information with others through the Internet. Social media can include blogs, business networks, enterprise social networks, forums, microblogs, photosharing sites, product/service review sites, social bookmarking, social gaming, social networks, video sharing, and virtual worlds. Social media can be used to share photos, videos, text, links to websites, and other information. For example, FACEBOOK® allows companies to share many types of information, including photos, videos, news articles, websites, or updates with designated groups of people, such as the public, friends, or other defined groups of people, such as those who have “liked” the company. TWITTER® allows companies to send short texts to followers of that company.

Many companies use more than one form of social media and Internet presence. On various websites, these companies give notice to users that they have a presence on other social media forms. For example, on a company's webpage, they may include an icon that links to their FACEBOOK® account, an icon that links to their TWITTER® account, and an icon that links to their YOUTUBE® account.

It would be advantageous for a company to provide promotional materials to customers that clearly set forth all of the company's Internet presence.

### SUMMARY OF THE INVENTION

The present invention provides for a promotional item including a promotional panel on an outer surface of the promotional item, wherein the promotional panel promotes a company and directs individuals to finding more information about the company through websites and social media sites.

The present invention provides for a method of making the promotional item, by printing a promotional panel on an outer surface of the promotional item, wherein the promotional panel promotes a company and directs individuals to finding more information about the company through websites and social media sites.

The present invention also provides for a method of advertising by providing a promotional item including a promotional panel associated with a company on an outer surface of the promotional item, and promoting the company.

### DESCRIPTION OF THE DRAWINGS

Other advantages of the present invention are readily appreciated as the same becomes better understood by reference to the following detailed description when considered in connection with the accompanying drawings wherein:

FIGS. 1A-1P are illustrations of promotional items including a promotional panel having social media and company information, wherein FIG. 1A shows a backpack, FIG. 1B shows a sweatshirt/hoodie, FIG. 1C shows a mug, FIG. 1D shows a long-sleeved t-shirt, FIG. 1E shows a short-sleeve t-shirt, FIG. 1F shows a USB or flash drive, FIG. 1G shows a water bottle, FIG. 1H shows an umbrella, FIG. 1I shows a poster, FIG. 1J shows a hat, FIG. 1K shows sweatpants, FIG. 1L shows a tank top, FIG. 1M shows a pen, FIG. 1N shows a mousepad, FIG. 10 shows a potholder, and FIG. 1P shows a notebook;

FIG. 2 is an illustration of an example of a promotional panel having social media and company information for the Detroit Pistons;

FIG. 3 is an illustration of the promotional panel of FIG. 2 on promotional t-shirts;

FIG. 4 is an illustration of an example of a promotional panel having social media and company information for the Cleveland Cavaliers;

FIG. 5 is an illustration of the promotional panel of FIG. 4 on promotional t-shirts;

FIG. 6 is an illustration of an example of a promotional panel having social media and company information; and

FIG. 7 is an illustration of the promotional panel of FIG. 6 on a promotional t-shirt.

### DETAILED DESCRIPTION OF THE INVENTION

The present invention provides for a promotional item, generally shown at 10 in the FIGURES, that can be used by a company in a method of advertising for their business. The promotional item 10 includes a promotional panel 12 on an outer surface 14 of the promotional item 10 that generally promotes a company and directs individuals to finding more information about the company through websites and social media sites. The promotional panel 12 can include any suitable identifying information about a company as described further below. The promotional panel 12 can direct individuals to be interactive with the company through websites and social media.

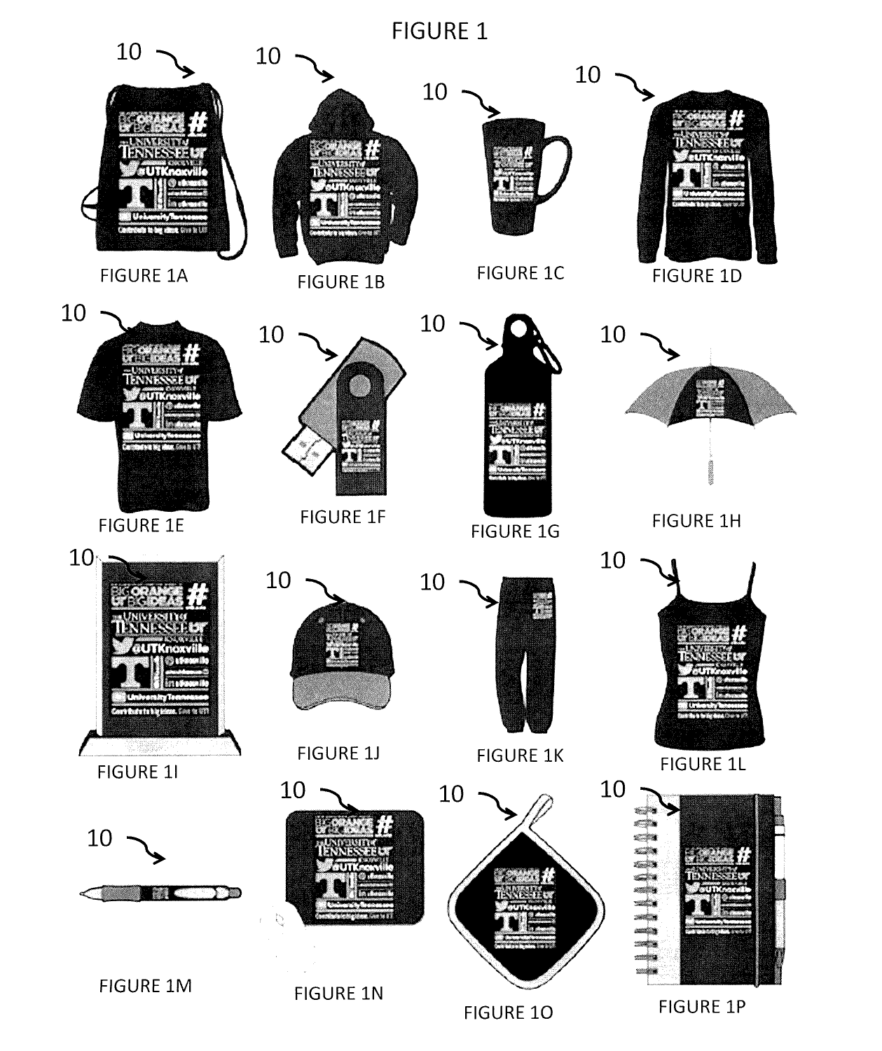

The promotional item 10 can take many different forms, as shown in FIGS. 1A-1P, such as, but not limited to, a backpack (1A), a sweatshirt/hoodie (1B), a mug (1C), a long-sleeved t-shirt (1D), a short-sleeve t-shirt (1E), a USB or flash drive (1F), a water bottle (1G), an umbrella (1H), a poster (1I), a hat (1J), sweatpants (1K), a tank top (1L), a pen (1M), a mousepad (1N), a potholder (1O), and a notebook (1P). The promotional item 10 can also be any type of garment, any type of paper (such as, but not limited to, postcards, leaflets, signs, magazine pages, newspaper pages, or business cards), or any other type of promotional product (such as, but not limited to, pencils, flags, beach towels, folders, phone covers, banners, billboards, tablecloths, displays, or signage).

The promotional panel 12 can be affixed to the outer surface 14 by any suitable method, and most preferably by printing. The printing can be with ink such as for paper products, or screen-printing methods for garments. Other methods of printing or affixation include, but are not limited to, embroidery, pad-printing, laser etching, pvc, digital printing, dye sublimation, applique, applying a patch, applying 3D foam, applying chenille, applying sequins, applying rhinestones, applying transfers, embossing, debossing, infusion, woven-in, prospangle, applying decals, applying labels, or applying badges.

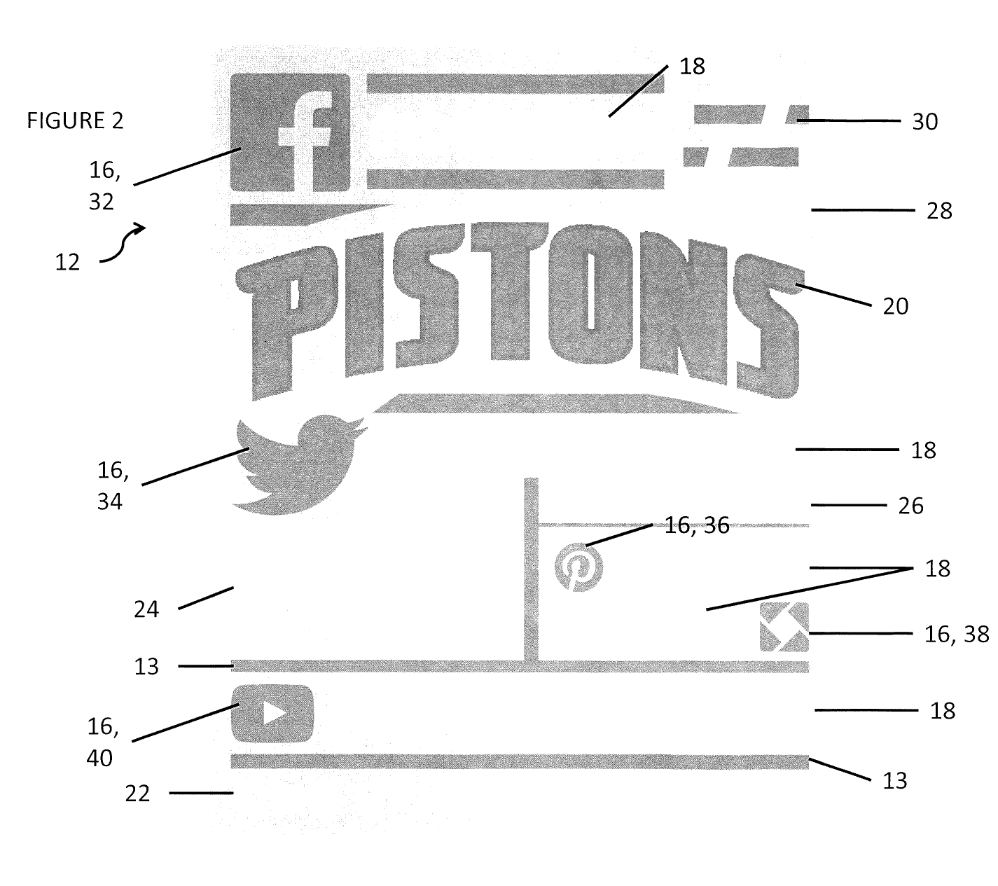

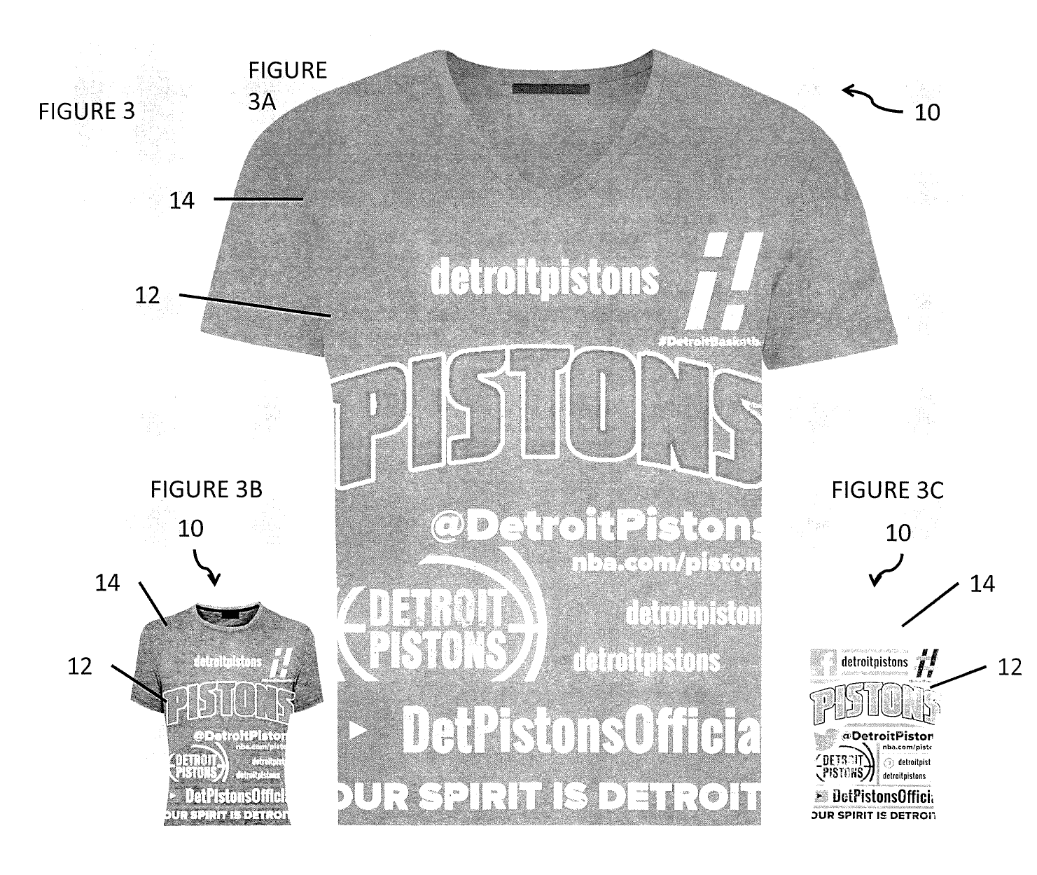

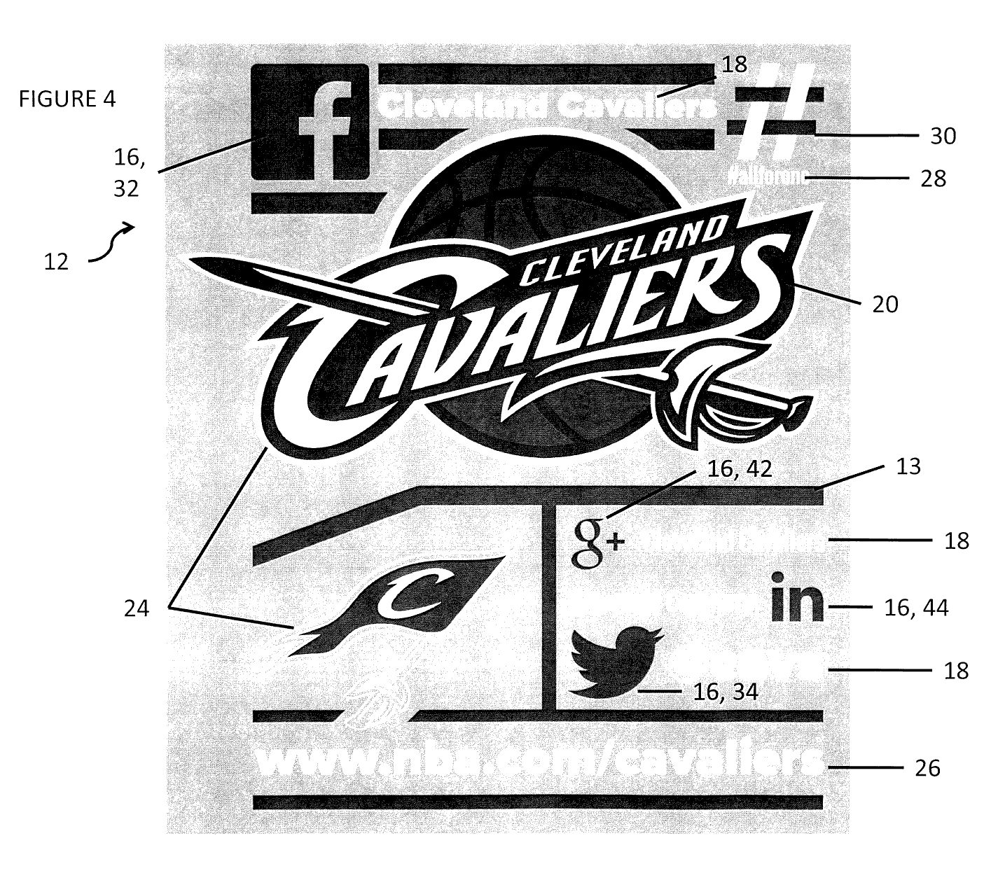

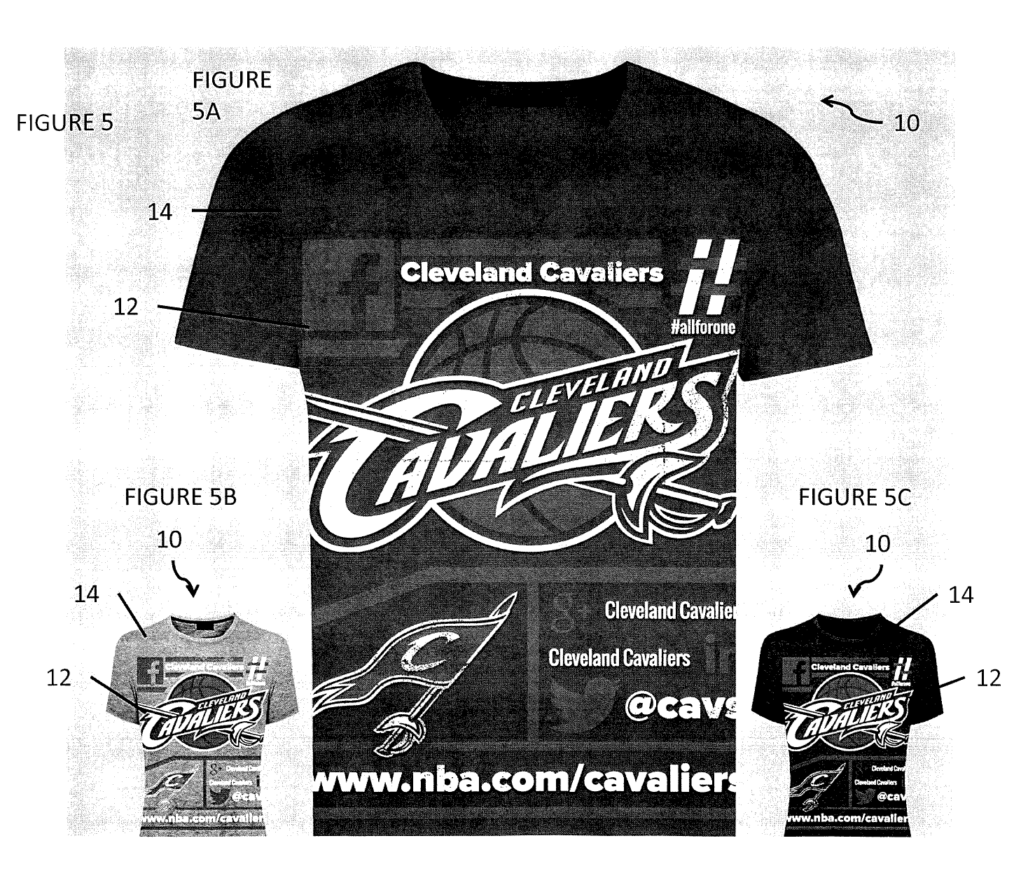

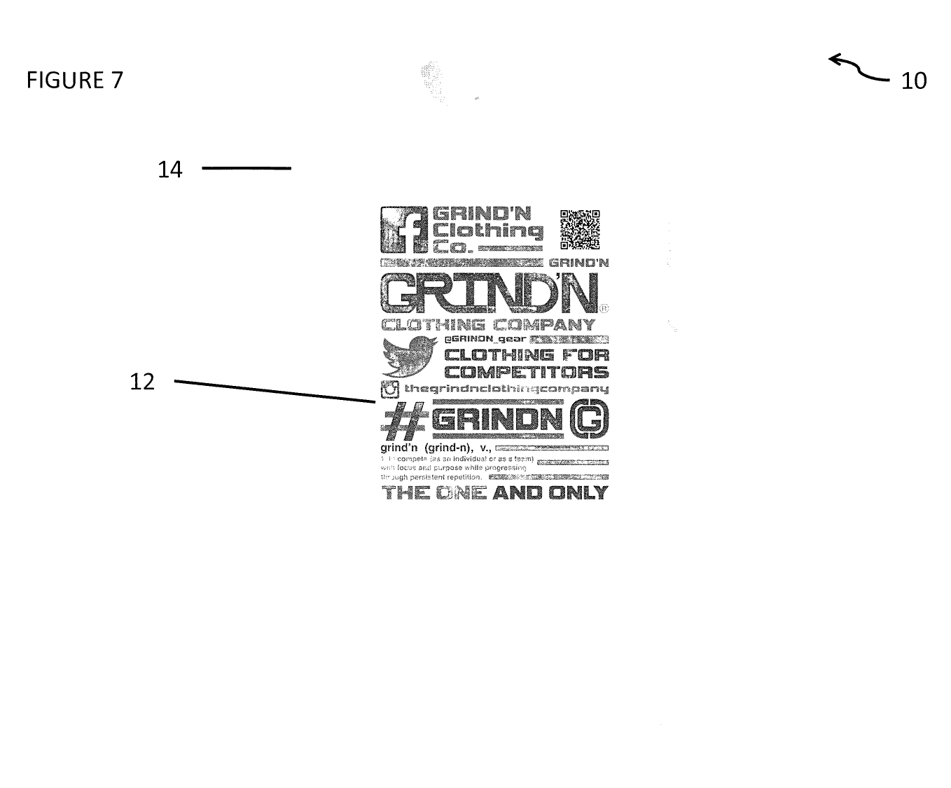

The promotional panel 12 is shown in detail in FIGS. 2, 4, and 6, using the Detroit Pistons and the Cleveland Cavaliers basketball teams as examples in FIGS. 2 and 4. The promotional panel 12 includes at least one social media icon 16 and a company social media page 18 (i.e. a website) associated with the social media icon 16, as well as a company name 20. The promotional panel 12 can also include at least one company slogan 22, at least one company logo 24, a company website 26, and at least one company-associated metadata tag 28 along with a hashtag icon 30, or combinations of any of the above information. The promotional panel 12 can be printed in any colors and preferably those colors associated with the company. The items within the promotional panel 12 can also be arranged in any suitable way and include additional borders 13 to separate items. FIGS. 3, 5, and 7 show the promotional panels 12 arranged on the surface 14 on promotional items 10 (t-shirts).

The social media icon 16 can be, but is not limited to, an icon associated with FACEBOOK® (32), TWITTER® (34), PINTEREST® (36), FOURSQUARE® (38), YOUTUBE® (40), GOOGLE+® (42), LINKEDIN® (44), INSTAGRAM® (46), SNAPCHAT® (not shown), or combinations thereof. The social media icon 16 can be from any existing social media company or from any that become popular in the future or are created in the future, i.e. the social media icon 16 is not limited to those listed above. The company name 20 can be alone or incorporated in the company logo 24, as shown in FIG. 4.

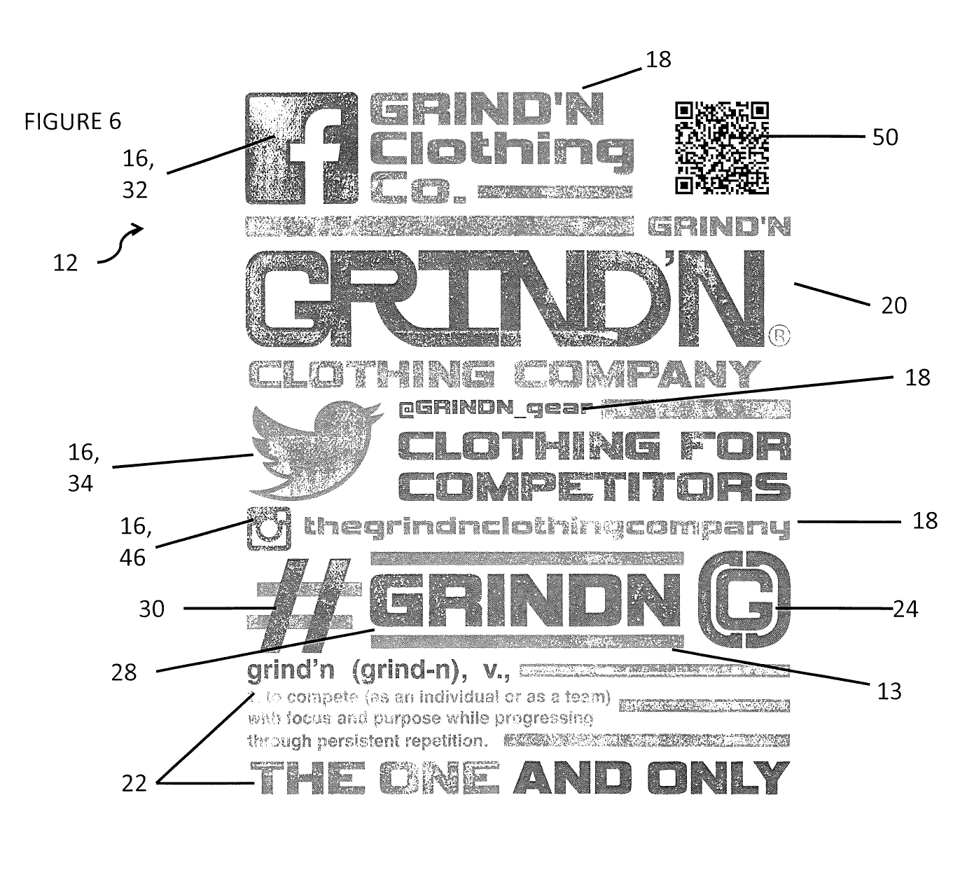

The promotional panel 12 can also include at least one QR code 50, shown in a promotional panel 12 in FIG. 6, that can be scanned and read by a QR reader on a mobile device (such as a tablet or smartphone). Each QR code 50 can be unique and direct a user to a specific page designated by the company, such as a company home page (webpage) or a specific social media page shown in the promotional panel 12. The QR code 50 can also direct a user to a single company page that includes links to each social media page 18 shown in the promotional panel 12. Multiple QR codes 50 can also be included for each social media page 18. The QR code 50 can always direct the user to the same page, or the user can be directed to a variable location based on the desire of the company. For example, a company can decide to direct the QR code 50 to a promotional page, a sweepstakes page, or a home page. In other words, the company can easily redirect the link associated with the QR code 50 on demand.

The present invention provides for a method of making the promotional item 10, by printing a promotional panel 12 on an outer surface 14 of the promotional item 10. As described above, the printing can be accomplished by ink printing methods or by screen-printing methods. The promotional item 10 can be any of those described above. Preferably, the promotional panel 12 includes the items described above, of at least one social media icon 16 and a company social media page 18 associated with the social media icon 16, as well as a company name 20. The promotional panel 12 can also include at least one company slogan 22, at least one company logo 24, a company website 26, and at least one company-associated metadata tag 28 along with a hashtag icon 30.

The present invention also provides for a method of advertising by providing a promotional item 10 including a promotional panel 12 associated with a company on an outer surface 14 of the promotional item 10, and promoting the company. The promotional item 10 can be any of those described above. Preferably, the promotional panel 12 includes the items described above, of at least one social media icon 16 and a company social media page 18 associated with the social media icon 16, as well as a company name 20. The promotional panel 12 can also include at least one company slogan 22, at least one company logo 24, a company website 26, and at least one company-associated metadata tag 28 along with a hashtag icon 30. The step of promoting the company can include selling the promotional item 10 to an individual, distributing the promotional item 10 to an individual, and offering the promotional item 10 at special events or contests to an individual. Once the individual has the promotional item 10, they are now aware of the company's online and social media presence and can follow the company on their various social media outlets. The promotional panel 12 can also include at least one QR code 50 and the method can include an individual interacting with the QR code 50 by scanning the QR code 50 with a QR reader on a mobile device and being directed to at least one company social media page 18 or other company designated page as described above. In this manner, the company can gain followers on each of their social media outlets.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A promotional item, comprising a promotional panel on an outer surface of said promotional item, wherein said promotional panel promotes a company and directs individuals to finding more information about the company through websites and social media sites.

2. The promotional item of clam 1, wherein said promotional item is chosen from the group consisting of a backpack, a sweatshirt/hoodie, a mug, a long-sleeved t-shirt, a short-sleeve t-shirt, a flash drive, a water bottle, an umbrella, a poster, a hat, sweatpants, a tank top, a pen, a mousepad, a potholder, a notebook, postcards, leaflets, signs, magazine pages, newspaper pages, business cards, pencils, flags, beach towels, folders, phone covers, banners, billboards, tablecloths, displays, and signage.

3. The promotional item of claim 1, wherein said promotional panel is affixed to said outer surface by a method chosen from the group consisting of ink printing, screen-printing, embroidery, pad-printing, laser etching, pvc, digital printing, dye sublimation, applique, applying a patch, applying 3D foam, applying chenille, applying sequins, applying rhinestones, applying transfers, embossing, debossing, infusion, woven-in, prospangle, applying decals, applying labels, and applying badges.

4. The promotional item of claim 1, wherein said promotional panel includes at least one social media icon, a company social media page, and a company name.

5. The promotional item of claim 4, wherein said promotional panel further includes information chosen from the group consisting of at least one company slogan, at least one company logo, a company website, at least one company-associated metadata tag with a hashtag icon, and combinations thereof.

6. The promotional item of claim 1, wherein said promotional panel includes borders separating company information.

7. The promotional item of claim 4, wherein said social media icon is chosen from the group consisting of FACEBOOK®, TWITTER®, PINTEREST®, FOURSQUARE®, YOUTUBE®, GOOGLE+®, LINKEDIN®, INSTAGRAM®, SNAPCHAT®, and combinations thereof.

8. The promotional item of claim 1, wherein said promotional panel further includes at least one QR code.

9. The promotional item of claim 9, wherein said QR code directs a user to a page chosen from the group consisting of a company home page, a company social media page, and a variable company page.

10. A method of making a promotional item, including the step of:
printing a promotional panel on an outer surface of the promotional item, wherein the promotional panel promotes a company and directs individuals to finding more information about the company through websites and social media sites.

11. The method of claim 10, wherein said printing step is further defined as a process chosen from the group consisting of ink printing, screen-printing, embroidery, pad-printing, laser etching, pvc, digital printing, dye sublimation, applique, applying a patch, applying 3D foam, applying chenille, applying sequins, applying rhinestones, applying transfers, embossing, debossing, infusion, woven-in, prospangle, applying decals, applying labels, and applying badges.

12. The method of claim 10, wherein the promotional item is chosen from the group consisting of a backpack, a sweatshirt/hoodie, a mug, a long-sleeved t-shirt, a short-sleeve t-shirt, a flash drive, a water bottle, an umbrella, a poster, a hat, sweatpants, a tank top, a pen, a mousepad, a potholder, a notebook, postcards, leaflets, signs, magazine pages, newspaper pages, business cards, pencils, flags, beach towels, folders, phone covers, banners, billboards, tablecloths, displays, and signage.

13. The method of claim 10, wherein the promotional panel includes at least one social media icon, a company social media page, and a company name.

14. The method of claim 13, wherein the promotional panel further includes information chosen from the group consisting of at least one company slogan, at least one company logo, a company website, at least one company-associated metadata tag with a hashtag icon, at least one QR code, and combinations thereof.

15. A method of advertising, including the steps of:
providing a promotional item including a promotional panel associated with a company on an outer surface of the promotional item; and
promoting the company.

16. The method of claim 15, wherein the promotional item is chosen from the group consisting of a backpack, a sweatshirt/hoodie, a mug, a long-sleeved t-shirt, a short-sleeve t-shirt, a flash drive, a water bottle, an umbrella, a poster, a hat, sweatpants, a tank top, a pen, a mousepad, a potholder, a notebook, postcards, leaflets, signs, magazine pages, newspaper pages, business cards, pencils, flags, beach towels, folders, phone covers, banners, billboards, tablecloths, displays, and signage.

17. The method of claim 15, wherein the promotional panel includes at least one social media icon, a company social media page, and a company name.

18. The method of claim 17, wherein the promotional panel further includes information chosen from the group consisting of at least one company slogan, at least one company logo, a company website, at least one company-associated metadata tag with a hashtag icon, at least one QR code, and combinations thereof.

19. The method of claim 15, wherein said step of promoting the company further includes a step chosen from the group consisting of selling the promotional item to an individual, distributing the promotional item to an individual, and offering the promotional item at special events or contests to an individual.

20. The method of claim 18, wherein the promotional panel includes at least one QR code and further including the step of an individual interacting with the QR code by scanning the QR code with a QR reader on a mobile device and directing the individual to at least one company social media page or company designated page.
